(19) United States
(12) Patent Application Publication
(10) Pub. No.: US 2008/0246624 A1
(43) Pub. Date: Oct. 9, 2008

(54) HEAT-DISSIPATING SYSTEM HAVING DUST DETECTING FUNCTION

(75) Inventors: ZHEN-XING YE, Shenzhen (CN); KE SUN, Shenzhen (CN); MING-KE CHEN, Shenzhen (CN); XIAO-ZHU CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (JP)

(21) Appl. No.: 11/930,172

(22) Filed: Oct. 31, 2007

(30) Foreign Application Priority Data
Apr. 4, 2007 (CN) 200710200393.0

(51) Int. Cl. G08B 21/00

(52) U.S. Cl. 340/679; 361/704

(57) ABSTRACT

A heat-dissipating system configured to dissipate heat from an electrical device, includes a heat sink having a plate on which dust is likely to accumulate if dust is present, a light-emitting element arranged on the plate of the heat sink, and an alarm. The alarm device is arranged on the plate of the heat sink and configured to receive light from the light-emitting element. If dust accumulates on the plate thick enough to block light so that the alarm device cannot receive light from the light-emitting element, the alarm device will activate.

### BACKGROUND

1. Field of the Invention

The present invention relates to heat-dissipating systems, and particularly to a heat-dissipating system which can detect dust status thereof.

2. Description of Related Art

Nowadays, computers are already used in many fields. When a computer is used, it is usually located in one place for a long time. Thereby a heat-dissipating device of the computer, such as a heat sink, may become covered in dust, and lose heat dissipation efficiency, which can shorten the lifespan of the computer.

Because the heat-dissipating device is generally located inside the computer, users can not easily see if dust is covering the heat-dissipating device. It is often not until function of the computer is affected, that users may take the trouble to check for excessive amounts of dust.

What is desired, therefore, is to provide a heat-dissipating system which can detect dust status thereof.

### SUMMARY

An embodiment of a heat-dissipating system configured to dissipate heat from an electrical device, includes a heat sink having a plate on which dust will most likely accumulate if it is present, a light-emitting element arranged on the plate of the heat sink, and an alarm. The alarm device is arranged on the plate of the heat sink and configured to receive light from the light-emitting element. If dust accumulates on the plate thick enough to block the light from the light-emitting element so that the alarm device cannot receive the light, the alarm device will activate an alarm.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is an isometric view of a heat-dissipating system in accordance with an embodiment of the present invention, with fins partially cut away to better show a light-emitting element and an alarm device of the heat-dissipating system;

FIG. 2 is a cross-sectional view taken along a line 11-11 of FIG. 1; and

FIG. 3 is a circuit diagram of the heat-dissipating system of FIG. 1.

### DETAILED DESCRIPTION

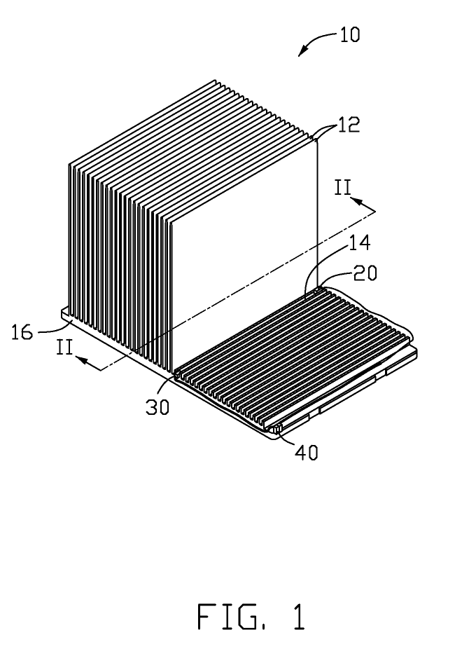

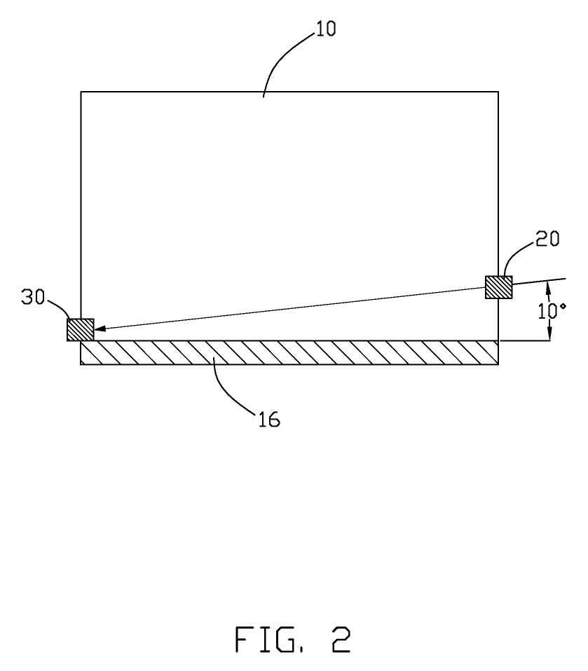

Referring to FIGS. 1 and 2, a heat-dissipating system in accordance with an embodiment of the present invention is configured to dissipate heat from a heat-generating electrical device such as a central processing unit (CPU) of a computer motherboard. The heat-dissipating system includes a heat sink 10 having a heat-absorbing base plate 16 and a plurality of parallel fins 12 extending upright from the heat-absorbing base plate 16, a light-emitting element 20, an alarm device 30, and a power connector 40. A channel 14 is defined between two adjacent fins 12. The light-emitting element 20 and the alarm device 30 are respectively arranged at opposite ends of the channel 14. The power connector 40 is arranged on an edge of the heat sink 10 for connecting to a power supply of the computer motherboard and supplying power from the power supply of the computer motherboard to the light-emitting element 20 and the alarm device 30.

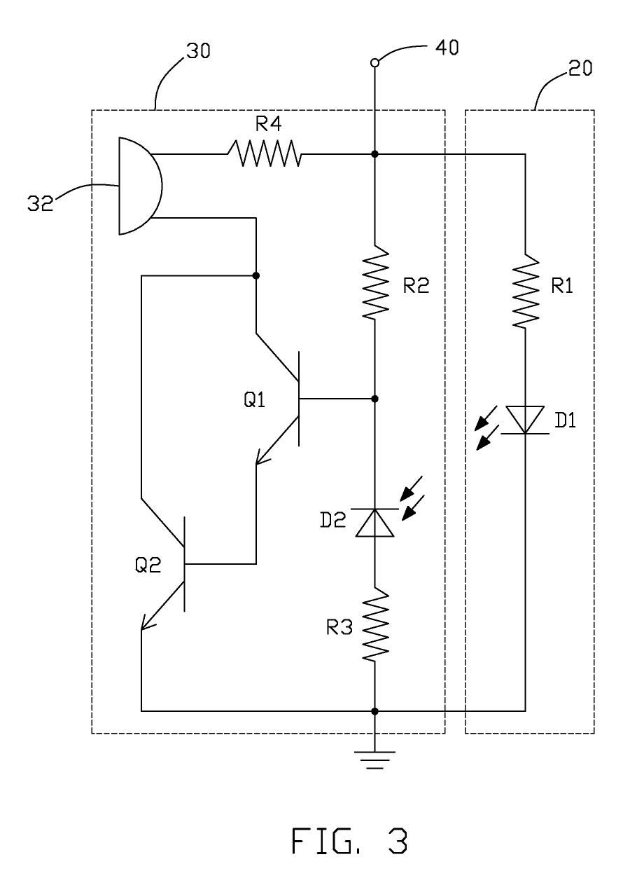

Referring also to FIG. 3, the light-emitting element 20 includes a light-emitting diode (LED) D1 and a first resistor R1. The cathode of the LED D1 is grounded. The anode of the LED D1 is connected to the power connector 40 via the first resistor R1. The LED D1 also can be replaced by other light-emitting element according to need.

The alarm device 30 includes a photosensitive diode D2, a second resistor R2, a third resistor R3, a fourth resistor R4, a first transistor Q1, a second transistor Q2, and a buzzer 32 having a power terminal and a ground terminal. The anode of the photosensitive diode D2 is grounded via the third resistor R3. The cathode of the photosensitive diode D2 is connected to the power connector 40 via the second resistor R2. The power terminal of the buzzer 32 is connected to the power connector 40 via the resistor R4. The ground terminal of the buzzer 32 is connected to the collectors of the first and second transistors Q1 and Q2. The base of the first transistor Q1 is connected to the cathode of the photosensitive diode D2. The emitter of the first transistor Q1 is connected to the base of the second transistor Q2. The emitter of the second transistor Q2 is grounded.

When the heat sink 10 is installed on the heat-generating electrical device, the power connector 40 is connected to a suitable power interface of the computer motherboard to receive power. After the computer motherboard is activated, the light-emitting element 20 and the alarm device 30 are supplied with power from the computer motherboard via the power connector 40 for a certain period of time such as 5 seconds, thereby the LED D1 will light up in this period. If little or no dust has accumulated on the heat sink 10, the photosensitive diode D2 will detect light of the LED Dl. Thus, the photosensitive diode D2 will turn on, and the first and second transistors Q1 and Q2 are off, thereby the buzzer 32 does not activate. If a lot of dust has accumulated on the heat sink 10 so that the photosensitive diode D2 cannot detect light of the LED D1, the photosensitive diode D2 will remain off, and the first and second transistors Q1 and Q2 turn on, thereby activating the buzzer 32 to alert users of the need to clean away accumulated dust.

In other embodiments, the light-emitting element 20, the alarm device 30, and the power connector 40 also can be arranged on other places of the computer motherboard according to need. The heat-dissipating system can alert users of the need of clearing dust in time, which can improve heat dissipation efficiency and prolong the lifespan of the computer motherboard.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat-dissipating system configured to dissipate heat from an electrical device, comprising:
a heat sink having a plate;
a light-emitting element arranged on the plate of the heat sink; and
an alarm device arranged on the plate of the heat sink and configured to receive light from the light-emitting element, if dust accumulates on the plate thick enough to block light so that the alarm device can not receive the light from the light-emitting element, the alarm device will be activated.

2. The heat-dissipating system as claimed in claim 1, wherein the plate is a heat-absorbing base plate of the heat sink configured to contact the electrical device, a plurality of fins extend from the plate, the light-emitting element and the alarm device are respectively arranged at opposite ends of a channel defined by two adjacent fins of the heat sink.

3. The heat-dissipating system as claimed in claim 2, wherein path of light traveling from the light-emitting element to the alarm device has an angle with the base plate of the heat sink.

4. The heat-dissipating system as claimed in claim 3, wherein the angle is approximately ten degrees.

5. The heat-dissipating system as claimed in claim 1, further comprising a power connector being arranged on the heat sink and configured to be connected to a power interface of the electrical device, the light-emitting element and the alarm device receiving power from the electrical device via the power connector.

6. The heat-dissipating system as claimed in claim 5, wherein the light-emitting element includes a light-emitting diode (LED) and a first resistor, the cathode of the LED is grounded, the anode of the LED is connected to the power connector via the first resistor.

7. The heat-dissipating system as claimed in claim 5, wherein the alarm device includes a photosensitive diode, a second resistor, a first transistor, a second transistor, and a buzzer having a power terminal and a ground terminal, the anode of the photosensitive diode is grounded, the cathode of the photosensitive diode is connected to the power connector via the second resistor, the power terminal of the buzzer is connected to the power connector, the ground terminal of the buzzer is connected to the collectors of the first and second transistors, the base of the first transistor is connected to the cathode of the photosensitive diode, the emitter of the first transistor is connected to the base of the second transistor, the emitter of the second transistor is grounded.

8. A heat-dissipating system configured to dissipate heat from an electrical device, comprising:
a heat sink;
an alarm device disposed on the heat sink; and
a light-emitting element disposed on an outer surface of the heat sink, the alarm device configured to receive light from the light-emitting element, if dust accumulates on the outer surface of the heat sink thick enough to block light so that the alarm device cannot receive light from the light-emitting element, the alarm device will activate.

9. The heat-dissipating system as claimed in claim 8, further comprising a power connector configured to be connected to a suitable power interface of the electrical device, the light-emitting element and the alarm device receiving power from the electrical device via the power connector.

10. The heat-dissipating system as claimed in claim 9, wherein the light-emitting element includes a light-emitting diode (LED) and a first resistor, the cathode of the LED is grounded, the anode of the LED is connected to the power connector via the first resistor.

11. The heat-dissipating system as claimed in claim 9, wherein the alarm device includes a photosensitive diode, a second resistor, a first transistor, a second transistor, and a buzzer having a power terminal and a ground terminal, the anode of the photosensitive diode is grounded, the cathode of the photosensitive diode is connected to the power connector via the second resistor, the power terminal of the buzzer is connected to the power connector, the ground terminal of the buzzer is connected to the collectors of the first and second transistors, the base of the first transistor is connected to the cathode of the photosensitive diode, the emitter of the first transistor is connected to the base of the second transistor, the emitter of the second transistor is grounded.

12. The heat-dissipating system as claimed in claim 8, wherein the heat sink comprises a heat-absorbing plate configured to contact the electrical device, a plurality of parallel fins extend from the plate, the light-emitting element and the alarm device are respectively arranged on the plate at opposite ends of a channel defined between two adjacent fins.
